(19) United States
(12) Patent Application Publication
(10) Pub. No.: US 2026/0289958 A1
(43) Pub. Date: Sep. 24, 2026

(54) IMAGE BACKGROUND SIMILARITY ANALYSIS METHOD AND APPARATUS, DEVICE, AND MEDIUM

(71) Applicant: Welab Information Technology (shenzhen) Limited., Shenzhen (CN)

(72) Inventors: Cheng Shao, Shenzhen (CN); Huanming Wu, Shenzhen (CN)

(21) Appl. No.: 19/235,639

(22) Filed: Jun. 12, 2025

(30) Foreign Application Priority Data
Mar. 20, 2025 (CN) 202510333740.5

(51) Int. Cl. G06V 10/74; G06T 7/194; G06V 10/26

(52) U.S. Cl. CPC G06V 10/761; G06T 7/194; G06V 10/26

(57) ABSTRACT

The present disclosure discloses an image background similarity analysis method, including: extracting an image background of a pre-acquired first image, and segmenting the extracted image background into an object region and a scene region; constructing a distribution vector according to the object region, and allocating an object region weight according to the distribution vector; calculating a weighting coefficient of the scene region, and utilizing the weighting coefficient of the scene region to construct a scene region weight; and calculating a similarity score of the image background of the first image and an image background of a second image according to a first object region weight, a first scene region weight, a second object region weight, and a second scene region weight. By calculating the weights of different regions, the similarity score between two image backgrounds may be calculated more accurately, thereby comparing the similarity score between them more accurately.

### CROSS REFERENCE TO RELATED APPLICATIONS

The present application claims the benefit of Chinese Patent Application No. 202510333740.5 filed on Mar. 20, 2025, the contents of which are incorporated herein by reference in their entirety.

### TECHNICAL FIELD

The present disclosure relates to the technical field of image processing, and more particularly relates to an image background similarity analysis method and apparatus, a device, and a medium.

### BACKGROUND

Image background similarity is a method for evaluating image similarity, which plays an important role in applications such as image matching, target detection, image classification, and image retrieval.

At present, the analysis of the image background similarity is mainly to extract background features of an image and calculate similarity between two image backgrounds. However, in some scenes, the backgrounds are often relatively similar, so that only extracting the backgrounds for similarity analysis may lead to the occurrence of misjudgment, and differences between different objects or regions cannot distinguished, thereby resulting in an inaccurate calculated similarity score.

### SUMMARY

The present disclosure provides an image background similarity analysis method and apparatus, a device, and a medium. By calculating weights of different regions, a similarity score between two image backgrounds may be calculated more accurately, thereby comparing the similarity score between them more accurately.

In a first aspect, an image background similarity analysis method is provided, including:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

In a second aspect, an image background similarity analysis apparatus is provided, including:
a first image processing module configured for extracting an image background of a pre-acquired first image, and segmenting the extracted image background into an object region and a scene region; constructing a first distribution vector according to the object region of the first image, and allocating a first object region weight according to the first distribution vector; and calculating a weighting coefficient of the scene region in the first image, and utilizing the weighting coefficient of the first scene region to construct a first scene region weight;
a second image processing module configured for extracting an image background of a pre-acquired second image, and segmenting the extracted image background into an object region and a scene region; constructing a second distribution vector according to the object region of the second image, and allocating a second object region weight according to the second distribution vector; and calculating a weighting coefficient of the scene region in the second image, and utilizing the weighting coefficient of the second scene region to construct a second scene region weight; and
a similarity analysis module configured for calculating a similarity score of the image background of the first image and the image background of the second image according to the first object region weight, the first scene region weight, the second object region weight, and the second scene region weight.

In a third aspect, an electronic device is provided, including a memory, a processor, and a computer program stored in the memory and runnable on the processor, wherein the computer program, when executed by the processor, implements the steps of the above image background similarity analysis method.

In a fourth aspect, a non-volatile computer-readable storage medium is provided, having a computer program stored thereon, wherein the computer program, when executed by a processor, implements the steps of the above image background similarity analysis method.

In the above solution implemented by the image background similarity analysis method and apparatus, the electronic device, and the storage medium, pixels of a non-target region in an image may be removed by background segmentation to reduce noise interference, so that a signal-to-noise ratio of a target region is higher; after the object region and the scene region are extracted, object recognition and scene understanding may be performed more accurately, so as to improve the accuracy and reliability of recognition and understanding results and provide a more accurate basis for subsequent image analysis and processing; by calculating the dynamic weight of the object region according to the distribution vector, the importance of the object region in the image may be reflected more reasonably, so as to better provide guidance for subsequent image processing tasks; meanwhile, by performing dynamic weight allocation on the object region and different partial scene regions, the processing time may be shortened; meanwhile, deeper and more detailed processing of more important regions may also be ensured, so that processing results are more precise and have high quality; and by calculating the weights of different regions, the similarity score between two segmented images may be calculated more accurately, which may help us decide the difference between two images, thereby comparing the similarity score between them more accurately.

### BRIEF DESCRIPTION OF THE ACCOMPANYING DRAWINGS

In order to explain the technical solutions of the examples of the present disclosure more clearly, a brief introduction to the accompanying drawings which are required to be used in the description of the examples of the present disclosure will be given below. It is apparent that the drawings in the description below are only some examples of the present disclosure, and for those ordinarily skilled in the art, other drawings may also be obtained according to these drawings without involving any inventive effort.

FIG. 1 is a schematic diagram of an application environment of an image background similarity analysis method in an example of the present disclosure;

FIG. 2 is a schematic flow diagram of the image background similarity analysis method in an example of the present disclosure;

FIG. 3 is a schematic structural diagram of an image background similarity analysis apparatus in an example of the present disclosure;

FIG. 4 is a schematic structural diagram of an electronic device in an example of the present disclosure; and

FIG. 5 is another schematic structural diagram of the electronic device in an example of the present disclosure.

### DETAILED DESCRIPTION OF ILLUSTRATED EMBODIMENTS

The technical solutions in the examples of the present disclosure will now be described clearly and completely below in conjunction with the accompanying drawings in the examples of the present disclosure. It is apparent that the described examples are some, but not all examples of the present disclosure. Based on the examples in the present disclosure, all other examples obtained by those ordinarily skilled in the art without involving any inventive effort fall within the scope of protection of the present disclosure.

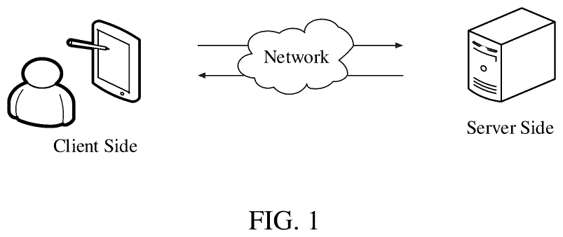

An image background similarity analysis method provided in an example of the present disclosure may be applied in an application environment as shown in FIG. 1, wherein a client communicates with a server via a network. The server may extract an image background of a pre-acquired first image, and segment the extracted image background into an object region and a scene region; construct a first distribution vector according to the object region of the first image, and allocate a first object region weight according to the first distribution vector; calculate a weighting coefficient of the scene region in the first image, and utilize the weighting coefficient of the first scene region to construct a first scene region weight; extract an image background of a pre-acquired second image, and segment the extracted image background into an object region and a scene region; construct a second distribution vector according to the object region of the second image, and allocate a second object region weight according to the second distribution vector; calculate a weighting coefficient of the scene region in the second image, and utilize the weighting coefficient of the second scene region to construct a second scene region weight; and calculate a similarity score of the image background of the first image and the image background of the second image according to the first object region weight, the first scene region weight, the second object region weight, and the second scene region weight, and feed the similarity score back to the client. The present disclosure provides an image background similarity analysis apparatus. For a similarity analysis service, an image background of a pre-acquired first image is extracted, and the extracted image background is segmented into an object region and a scene region; a first distribution vector is constructed according to the object region of the first image, and a first object region weight is allocated according to the first distribution vector; a weighting coefficient of the scene region in the first image is calculated, and the weighting coefficient of the first scene region is utilized to construct a first scene region weight; an image background of a pre-acquired second image is extracted, and the extracted image background is segmented into an object region and a scene region; a second distribution vector is constructed according to the object region of the second image, and a second object region weight is allocated according to the second distribution vector; a weighting coefficient of the scene region in the second image is calculated, and the weighting coefficient of the second scene region is utilized to construct a second scene region weight; and a similarity score of the image background of the first image and the image background of the second image is calculated according to the first object region weight, the first scene region weight, the second object region weight, and the second scene region weight. By calculating the weights of different regions, the similarity score between two image backgrounds may be calculated more accurately, thereby comparing the similarity score between them more accurately, wherein the client may be, but is not limited to, various personal computers, notebook computers, smart phones, tablet computers, and portable wearable devices. The server may be implemented by using a stand-alone server or a server cluster consisting of a plurality of servers. The present disclosure will now be described in detail by way of specific examples.

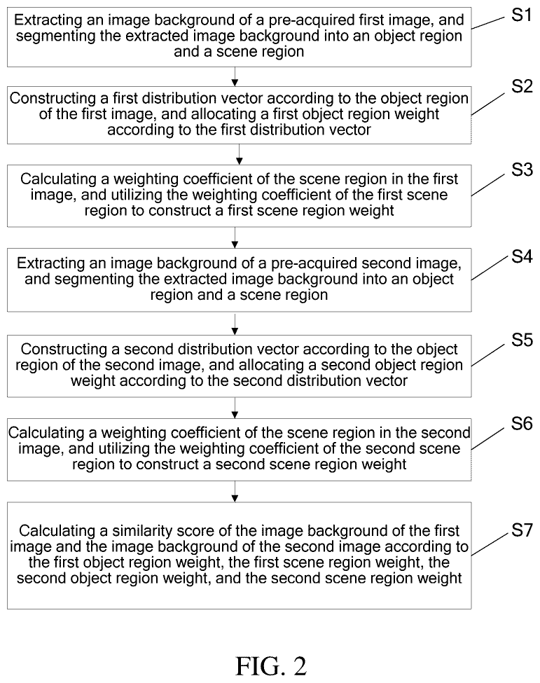

With reference to FIG. 2, FIG. 2 is a schematic flow diagram of an image background similarity analysis method provided in an example of the present disclosure, including the following steps.

S1, extracting an image background of a pre-acquired first image, and segmenting the extracted image background into an object region and a scene region.

In the example of the present disclosure, the extraction refers to separately segmenting a background part in the image to form a new background image or a background mask, and the segmentation refers to respectively extracting and obtaining pixel points contained in the object region and pixel points contained in the scene region according to the image background of the first image.

Specifically, in a pre-processing process, background segmentation may be performed on the first image by a threshold segmentation method or an image segmentation method, and the obtained background segmentation of the first image may be used as an input for image similarity calculation; and when the object region and the scene region are extracted, it is necessary to select suitable segmentation algorithms and parameters to achieve optimal segmentation effects according to specific application scenes and requirements, and for specific targets and background features, reasonable post-processing operation is performed to improve the accuracy and reliability of image processing and analysis.

In the example of the present disclosure, the extracting an image background of a pre-acquired first image, includes:
performing enhancement processing on the pre-acquired first image to obtain a first enhanced image;
extracting background pixels of the first enhanced image; and
performing background segmentation on the first enhanced image according to the background pixels to obtain the image background of the first image.

In the example of the present disclosure, the enhancement processing refers to performing a series of processing on the image to improve the performance of the image in terms of quality, contrast, sharpness, brightness, and the like, the extraction refers to extracting the pixels belonging to the background part from the image, and the background segmentation refers to separately segmenting the background part in the image to form a new background image or a background mask.

Specifically, the first image is subjected to processing such as noise removal and contrast enhancement, and the noise removal may be performed by adopting a filter, such as median filtering and Gaussian filtering; histogram stretching and histogram equalization may be adopted to enhance the contrast; further, a contour and texture of the image are enhanced by highlighting edges and details, a commonly used method is Laplacian sharpening, and a Gaussian filter and a Laplacian filter may be used for image sharpening.

Further, the background pixels are selected by means of manual selection or automatic selection according to features of the enhanced image, and if the automatic selection is adopted, methods such as threshold segmentation or clustering may be used; on the basis of background pixel extraction, a fixed threshold method may be adopted to segment the image, and for each pixel, if the pixel belongs to the background, the pixel is set to be black, otherwise, the pixel is set to be white; and this method is simple and easy to understand, but it is necessary to set a suitable threshold manually, and too high or too low thresholds will lead to a poor segmentation effect.

In addition, a Gaussian mixture model (GMM) may also be adopted to model distribution of background pixels, and pixels located below a certain random segmentation point in the distribution may be judged as background pixels; and this method can adapt to complex distribution of the background pixels and can automatically estimate the threshold, but the segmentation effect may be unstable in complex image scenes.

In the example of the present disclosure, the segmenting the extracted image background into an object region and a scene region, includes:
performing object mask segmentation on the image background of the first image to obtain the object region of the first image;
performing scene analysis on the image background of the first image to obtain an analysis result; and
performing scene mask segmentation on the image background of the first image according to the analysis result to obtain the scene region of the first image.

In the example of the present disclosure, the object mask segmentation refers to performing accurate pixel-level segmentation on the object region, and the scene analysis refers to performing semantic analysis and reasoning on a scene based on category information about an object and context information about the scene, and recognizing elements such as a theme, an activity, and an environment existing in the scene, so as to decide the scene; and the scene mask segmentation refers to performing accurate pixel-level segmentation on the scene region.

Specifically, the first image is segmented into the object and the background by performing operation such as iterative segmentation or region growing on a foreground object using an object mask generation algorithm, and the object mask is generally a binary image, wherein a pixel value of the object region is 1, a pixel value of a background region is 0, and the generated object mask may be further processed and analyzed by using algorithms such as morphological processing and connected component analysis; and for example, the morphological processing algorithm may be used to morphologically transform the object mask to remove noise and small objects. In addition, the connected component analysis algorithm may also be used to perform filtering or merging operation on isolated regions or small regions in the object mask, and after the object mask is obtained, the object mask also needs to be post-processed to further optimize a boundary and a shape of the object region to obtain the object region.

In detail, the object region in the first image is recognized to acquire category information about the object, semantic analysis and reasoning of the scene are performed based on the category information about the object and the context information about the scene, and the elements such as the theme, the activity, and the environment existing in the scene are recognized, the scene is understood and interpreted, and it is inferred that the object in the scene belongs to which kind of scene in the real world, such as an indoor scene, an outdoor scene, urban streets, and natural scenery. Scene mask segmentation is performed on the image background of the first image according to the above analysis result to obtain the scene region of the first image.

In the example of the present disclosure, for the image after being subjected to enhancement processing, noise and background features are better separated, which is advantageous to adopting a more accurate method to extract background pixels, thereby effectively reducing segmentation noise interference; meanwhile, the desired target may be better separated from the background by the background segmentation to eliminate interference information and improve the accuracy of target segmentation; and the image after being subjected to enhancement and segmentation processing is the image background of the first image, which may be directly used in image processing, and the time and calculation amount for extracting the background pixels again and segmenting are saved, so as to facilitate subsequent image processing.

In the example of the present disclosure, pixels of a non-target region in the image may be removed by background segmentation to reduce noise interference, so that a signal-to-noise ratio of a target region is higher; and after the object region and the scene region are extracted, object recognition and scene understanding may be performed more accurately, so as to improve the accuracy and reliability of recognition and understanding results and provide a more accurate basis for subsequent image analysis and processing.

S2, constructing a first distribution vector according to the object region of the first image, and allocating a first object region weight according to the first distribution vector.

In the example of the present disclosure, the construction refers to grouping the object regions detected in the first image according to object categories to which the object regions belong, performing statistics on a frequency of occurrence of each category in the image, and constructing these frequencies into a vector; and the allocation refers to a process of dynamically balancing and adjusting the importance of the object region by assigning different weight values to different object regions in the image according to the weights of the object regions in the first distribution vector.

Specifically, the process of constructing the first distribution vector is widely applied, for example, may be used in the fields such as object detection, image processing, and computer vision. Through the calculation and analysis of the occurrence frequency of the objects, the distribution of the objects may be better understood, so as to facilitate subsequent object recognition and processing.

Further, according to the occurrence frequencies or the weights of the object regions, the allocation of the weights to the object regions can be balanced according to the importance thereof. If the occurrence frequency of a certain group of object categories is high, it is indicated that this group of object categories is more significant in the whole image, and then a higher weight should be given.

In the example of the present disclosure, the constructing a first distribution vector according to the object region of the first image, includes:
recognizing object categories of the object region of the first image;
performing homogeneous grouping according to the object categories to obtain the object categories corresponding to each group;
performing frequency statistics on the object categories corresponding to each group to obtain a frequency of each group of object categories; and
constructing a frequency distribution vector for the object region of the first image according to the frequency of each group of object categories to obtain the first distribution vector.

In the example of the present disclosure, the recognition refers to performing object recognition on all the object regions in the image and determining the object categories to which the object regions respectively belong, the homogeneous grouping refers to grouping all the objects detected in the image according to the categories to which the objects belong, wherein each group corresponds to one different object category, the frequency statistics refers to performing statistics on the occurrence frequency of each category group in the image for each category group, and the construction refers to constructing the frequency corresponding to each category group into a frequency distribution vector for each category group.

Specifically, firstly, all the objects are detected from the object region in the first image and marked out; and this step may be completed by using technologies such as an object detection model based on deep learning and a conventional object detection algorithm, then all the objects detected are grouped according to categories, each group corresponds to one different object category, and category grouping may be achieved by using data structures such as a dictionary and a Hash table; and for each category group, statistics on the occurrence frequency thereof in the image is performed. Specifically, the whole image may be traversed, and for each pixel, it is decided that whether the pixel belongs to a certain group of object categories, and then the frequency of the corresponding category in the group is increased by 1; for each category group, a frequency sequence corresponding to the category group is constructed into one frequency distribution vector; and a dimension size of the frequency distribution vector should be the same as the number of the object categories, each dimension corresponds to one different object category, and a value thereof corresponds to the number of times the category occurs in the frequency distribution.

In addition, the object region may also be segmented into a plurality of grid regions according to a preset rule, for each grid region, all the pixels therein are traversed, and for each pixel, color information thereof is extracted and counting statistics is performed, namely, the occurrence number of each color is accumulated, after statistics on the occurrence number of the colors of all the pixels is performed, a color frequency of the grid region is obtained, the color frequency may be put into one vector, for each element in the vector, the occurrence number of the color in the grid region is represented, and after statistics on the color frequencies of all the grid regions is performed, color frequency distribution of the whole object region may be obtained, and the distribution may be used for the description and extraction of color features of the objects.

Further, for each grid region, a color frequency vector thereof is normalized to a color distribution feature vector, and the following method may be adopted: the color frequency vector is divided by the sum of all the elements, so that the sum of all the elements is 1; and each element of the color distribution vector is divided by the radication of the quadratic sum of all the elements of the vector, and the color distribution feature vectors obtained from each grid region are combined into the color distribution feature vector of the grid region, for example, the feature vectors of all the grid regions are concatenated together to obtain a total color distribution feature vector.

In addition, a prepared training dataset may also be used to train one deep learning model, such as a convolution neural network (CNN), for extracting a depth feature vector of each object; and in the training process, a loss function such as cross entropy may be adopted for optimization, updating and iteration of the weights are performed by a back propagation algorithm, and deep extraction of the object in the image is performed by using the trained deep learning model to obtain the depth feature vector of the object. By using the above method, the depth feature vector of the object in the image is extracted and the frequency distribution vector is constructed.

Specifically, for the background object of the input image, the feature of each pixel in the picture is extracted by means of the convolution neural network (CNN), and the like to obtain a feature map, the feature of each pixel in the picture is encoded by constructing Query, Key and Value vectors utilizing a Self-Attention mechanism, and in this process, the feature of each pixel is regarded as Key and Value, so as to help the network to better memorize and capture the picture feature, while the Query vector is constructed into a category vector for each object category. Based on the above constructed Query, Key and Value vectors, the similarity distribution between each pixel in the picture may be obtained by executing corresponding operation, so as to calculate an importance weight of each pixel which needs to be concerned.

In the example of the present disclosure, the allocating a first object region weight according to the first distribution vector, includes:
performing feature extraction on the object region of the first image to obtain a first feature image;
constructing a dynamic weight vector corresponding to the object region of the first image according to the first distribution vector; and
weighting the first feature image and the dynamic weight vector to obtain the first object region weight.

In the example of the present disclosure, the feature extraction refers to extracting a representative feature from the object region for subsequent tasks such as object recognition, classification, and positioning, the construction refers to calculating the frequency distribution vector and then converting the frequency distribution vector into the dynamic weight vector, and the weighting processing refers to a process of multiplying the dynamic weight vector obtained by construction by the first feature image pixel by pixel.

Specifically, the feature of the input image is extracted, for example, the feature extraction is performed on the image by using the convolution neural network to obtain the first feature image, and then the corresponding dynamic weight vector is constructed according to each object category detected, wherein this vector is generally composed of two parts: firstly, higher weights are assigned to the pixels near the position of the object of the corresponding category, and secondly, lower weights are assigned to the pixels farther away from the object, and a specific form of the dynamic weight vector may be adjusted according to the requirements of the tasks.

In detail, the dynamic weight vector obtained by construction is multiplied by the feature map pixel by pixel to obtain a weighted synthetized feature map, namely, a processing result. In this process, the higher weights are assigned to the object regions which need critical concern, while lowered weights are assigned to other regions, so as to preserve the most important object information and reduce interference; and the dynamic weight of each object category is dynamically allocated by utilizing the object position and category information, and the object information is extracted and weighted through the process of executing dynamic allocation, so that more accurate and effective classification results are obtained.

In the example of the present disclosure, the dynamic weight vector is calculated according to the first distribution vector, and may reflect the importance degree of each object region in the image. By combining the dynamic weight vector with other image processing algorithms, more intelligent and self-adaptive image processing may be achieved, and meanwhile, it is convenient to construct different dynamic weight vectors according to different tasks or application scenes, so as to achieve a more flexible image processing flow. By weighting the first feature image and the dynamic weight vector, the weight of each object region may be obtained more accurately, so as to better reflect the importance of the object region.

In the example of the present disclosure, after the object region and the scene region are extracted, object recognition and scene understanding may be performed more accurately, thereby improving the accuracy and reliability of recognition and understanding results, and providing a more accurate basis for subsequent image analysis and processing; by constructing the frequency distribution vector, the occurrence frequency of each object in the image may be understood, so that the distribution of the objects may be better understood. Meanwhile, the first distribution vector may represent the color distribution of the object region, and this representation way is more intuitive and convenient for comparison and comparative analysis between different object regions; and the first distribution vector may also be used to improve the performance of a machine learning algorithm.

In the example of the present disclosure, by calculating the dynamic weight of the object region according to the first distribution vector, the importance of the object region in the image may be reflected more reasonably, so as to better provide guidance for subsequent image processing tasks; and the importance degrees of different object regions in the image may be obtained according to the first distribution vector, so as to provide suitable processing strategies for different image processing tasks.

S3, calculating a weighting coefficient of the scene region in the first image, and utilizing the weighting coefficient of the first scene region to construct a first scene region weight.

In the example of the present disclosure, the calculation refers to calculating a weighting coefficient for each sub-region in all the sub-regions of the whole scene region according to the feature of each sub-region and a judgment result of a scene category to which the sub-region belongs, so as to represent the contribution degree of the sub-region to the whole scene, and the construction refers to constructing a processing weight of each sub-region according to the weighting coefficient of each sub-region and a current state of the whole scene region.

Specifically, for different scenes and target objects, different information features of the target region may be obtained by an image analysis algorithm, and then the weight is allocated to each scene region in combination with the weighting coefficient.

In the example of the present disclosure, the calculating a weighting coefficient of the scene region in the first image, includes:
dividing the scene region of the first image into a plurality of groups of partial scene regions;
performing feature analysis on the partial scene regions one by one to obtain partial scene features;
recognizing partial scene types according to the partial scene features;
performing weighting coefficient calculation on the partial scene regions one by one the partial scene regions; and
generating the weighting coefficient of the scene region in the first image according to a combination of the partial scene weighting coefficients.

In the example of the present disclosure, the division refers to dividing the whole scene region into a plurality of sub-regions, the feature analysis refers to analyzing different parts of the scene to understand feature information such as color, texture and a shape of each part, the recognition refers to recognizing the scene type to which the sub-region belongs by performing feature extraction and processing on each sub-region, and the weighting coefficient calculation refers to calculating the weighting coefficient for each sub-region in all the sub-regions of the whole scene region according to the feature of each sub-region and the judgment result of the scene category to which the sub-region belongs, so as to represent the contribution degree of the sub-region to the whole scene.

Specifically, the whole scene region is divided into a plurality of regions with obvious boundaries. For example, in one picture, a part belonging to the sky, a part of a building, a part of vegetation, a part of a road, and the like, may be respectively divided into different sub-regions, then the features such as color distribution, a texture feature and object layout of each sub-region are extracted, and these features are matched with predefined scene categories to determine the scene type to which each sub-region belongs. By taking an indoor picture for an example, the picture may be segmented into a plurality of sub-regions such as a region containing tables and chairs, a window and an indoor region, then respective features thereof are extracted for these sub-regions, and the scene types to which the sub-regions belong are determined according to these features, such as an office, a bedroom and a living room.

Further, there are various algorithms suitable for performing the weighting coefficient calculation on the partial scene regions one by one, for example, a weight calculation algorithm based on statistical features may be adopted (such as an information entropy algorithm, namely, information entropy of pixels in the sub-regions is calculated, and the higher the entropy value is, the greater the weight is; or a variance or standard deviation algorithm may be adopted, namely, the greater the variance of pixel values in the sub-regions is, the more details or edges may be contained, and the higher the weight is; and a formula may be

$${W}_{i} = {σ}_{i}^{2}$$

(σᵢ is the variance of the pixel values in the i^{th} sub-region, and Wᵢ is a correlation coefficient of the i^{th} sub-region)).

In the example of the present disclosure, the utilizing the weighting coefficient of the first scene region to construct a first scene region weight, includes:
performing dynamic weight allocation on the partial scene regions according to the partial scene weighting coefficients to obtain partial scene dynamic weights; and
generating the first scene region weight according to a combination of the partial scene dynamic weights.

In the example of the present disclosure, the dynamic weight allocation refers to weighting different parts of the scene region according to an image analysis result and a distribution vector, so as to obtain a corresponding weight value of each scene region.

Specifically, the obtained weighting coefficient may be used to determine the importance degree of each sub-region in the whole scene, and each sub-region is weighted according to these coefficients, for example, the sub-regions with larger weighting coefficients should also have larger processing weights, so that these important regions are more concerned, so as to perform deeper processing and improvement. In contrast, for the sub-regions with smaller weighting coefficients, the processing weights may also be correspondingly lowered, so as to reduce the processing of these sub-regions, and avoid affecting the processing efficiency and achievement. Finally, the dynamic weight allocation may be implemented with various algorithms according to actual situations, such as dynamic weight allocation based on the weighting coefficients, and dynamic weight allocation based on the states.

In the example of the present disclosure, after the whole scene region is divided into a plurality of sub-regions, the feature analysis of each sub-region is more detailed, and the scene category to which each sub-region belongs may be determined more accurately, thereby improving the accuracy of classification of the whole scene; the partial scene feature recognition achieves the local analysis of the scene region, thereby reducing a processing scale of the whole image, improving the efficiency and speed of image processing, and enabling the image analysis to be more efficient and quicker; the processing time may be shortened by performing the weighting coefficient calculation on different partial scene regions and performing the dynamic weight allocation on the partial scene regions according to this; and by performing the weighting coefficient calculation on different partial scenes and performing the dynamic weight allocation on the partial scene regions according to this, deeper and more detailed processing of more important regions may be ensured, so that processing results are more precise and have high quality.

In the example of the present disclosure, the dynamic weight allocation may enable the processing time to be more efficient. When the image processing is performed, only those partial scenes with higher weights need to be processed, while those partial scenes with lower weights do not need to be processed too much, which may improve the processing efficiency; meanwhile, the flexibility of image processing may be enhanced, so that the algorithm is more adaptive to different scenes and applications.

S4, extracting an image background of a pre-acquired second image, and segmenting the extracted image background into an object region and a scene region.

In the example of the present disclosure, the step of extracting an image background of a pre-acquired second image, and segmenting the extracted image background into an object region and a scene region is the same as the step S1 described above, which will not be described in detail herein.

Specifically, background segmentation is performed on the second image by a threshold segmentation method or an image segmentation method; when the object region and the scene region of the image background of the second image are extracted, according to the specific application scenes and requirements, suitable segmentation algorithms and parameters are selected to achieve the optimal segmentation effect, and reasonable post-processing operation is performed for the specific targets and background features.

S5, constructing a second distribution vector according to the object region of the second image, and allocating a second object region weight according to the second distribution vector.

In the example of the present disclosure, the step of constructing a second distribution vector according to the object region of the second image, and allocating a second object region weight according to the second distribution vector is the same as the step S2 described above, which will not be described in detail herein.

Specifically, the process of constructing the second distribution vector may be performed by adopting object detection, image processing, and computer vision. Through the calculation and analysis of the occurrence frequencies of objects, the distribution of the objects may be better understood. The vector is constructed according to the occurrence frequencies of the object regions, so that according to the vector, the weights are allocated to the object regions according to the vector. If the occurrence frequency of a certain group of object categories is high, it is indicated that this group of object categories is more significant in the whole image, and then a higher weight should be given.

S6, calculating a weighting coefficient of the scene region in the second image, and utilizing the weighting coefficient of the second scene region to construct a second scene region weight.

In the example of the present disclosure, the step of calculating a weighting coefficient of the scene region in the second image, and utilizing the weighting coefficient of the second scene region to construct a second scene region weight is the same as the step S3 described above, which will not be described in detail herein.

Specifically, for different scenes and target objects of the scene region in the second image, different information features of the target region may be obtained by an image analysis algorithm, and then the weight is allocated to each scene region in combination with the weighting coefficient.

S7, calculating a similarity score of the image background of the first image and the image background of the second image according to the first object region weight, the first scene region weight, the second object region weight, and the second scene region weight.

In the example of the present disclosure, the calculation refers to extracting and calculating image background regions of two images, and calculating the similarity score between two image backgrounds according to weight values of different regions.

Specifically, calculating the similarity score of the image background of the first image and the image background of the second image according to the first object region weight, the first scene region weight, the second object region weight, and the second scene region weight, includes region division, similarity calculation, weight allocation and weighting, so as to evaluate the similarity between different images and the contribution of different scenes and objects to the similarity between the images more accurately.

In the example of the present disclosure, the calculating a similarity score of the image background of the first image and the image background of the second image according to the first object region weight, the first scene region weight, the second object region weight, and the second scene region weight, includes:
calculating a similarity score of the object region of the first image and the object region of the second image according to the first object region weight and the second object region weight;
calculating a similarity score of the scene region of the first image and the scene region of the second image according to the first scene region weight and the second scene region weight;
calculating an initial similarity score of the image background of the first image and the image background of the second image; and
performing weighted fusion on the similarity score of the object regions, the similarity score of the scene regions, and the initial similarity score to obtain the similarity score of the image background of the first image and the image background of the second image.

In the example of the present disclosure, the calculation refers to comparing the similarity scores between the object regions and the scene regions in two segmented images and between the two segmented images, and the weighted fusion refers to performing weighted summation on different similarity score indexes to obtain a comprehensive similarity score.

Specifically, the similarity scores are calculated for the object regions, the scene regions, and the two image backgrounds, various image similarity algorithms (such as SSIM and PSNR) may be adopted to calculate the similarity scores, weight values are calculated according to the first object region weight, the first scene region weight, the second object region weight, and the second scene region weight, and all the region scores are weighted to obtain the similarity score of the whole image.

In addition, a multi-task learning framework may also be utilized to optimize weight factors of scene region and object region features. A commonly used optimization method is to update the weight through a task loss function step by step. In an initial stage, the weight factors may be initialized in a uniform distribution manner; and for example, the weighting factors may be initialized to uniformly distributed random values, the weights are continually adjusted in a subsequent training process to improve the performance of a model, and the task loss functions may be used to update the weights in the training process, with the commonly used loss functions including a mean square error (MSE), cross-entropy, and the like.

Specifically, firstly an objective function is defined, then a gradient of the model is calculated by using the objective function, calculation is performed by taking the weight factor as an independent variable, and the weight factor is updated by utilizing the gradient obtained by the calculation. Generally, an optimization algorithm such as random gradient descent (SGD) or Newton method may be adopted to update the weight, and the first three steps are repeatedly performed until the model converges, and finally the similarity score of the two images is obtained.

In the example of the present disclosure, the similarity scores of the scene regions and the object regions in the image backgrounds may be used as supplementary information to help the model calculate the similarity of the images more accurately and improve the accuracy of the calculation results; meanwhile, by calculating the similarity score of the object regions, the similarity and difference between the objects may be better captured, so as to improve the effect of target tracking; and by calculating the similarity score of the scene regions, the robustness of the algorithm may be increased, so that the algorithm is more adaptive to picture processing tasks in different scenes.

In the example of the present disclosure, by calculating the weights of different regions, the similarity score between two segmented images may be calculated more accurately, which may well help us decide the difference between the two image backgrounds, thereby comparing the similarity score between them more accurately; meanwhile, the similarity score between the two image backgrounds may be intuitively presented, which may well help us compare the similarity of the two image backgrounds, thereby improving the quality of image matching.

It can be seen that in the above solution, for a similarity analysis service, an image background of a pre-acquired first image is extracted, and the extracted image background is segmented into an object region and a scene region; a first distribution vector is constructed according to the object region of the first image, and a first object region weight is allocated according to the first distribution vector; a weighting coefficient of the scene region in the first image is calculated, and the weighting coefficient of the first scene region is utilized to construct a first scene region weight; an image background of a pre-acquired second image is extracted, and the extracted image background is segmented into an object region and a scene region; a second distribution vector is constructed according to the object region of the second image, and a second object region weight is allocated according to the second distribution vector; a weighting coefficient of the scene region in the second image is calculated, and the weighting coefficient of the second scene region is utilized to construct a second scene region weight; and a similarity score of the image background of the first image and the image background of the second image is calculated according to the first object region weight, the first scene region weight, the second object region weight, and the second scene region weight. By calculating the weights of different regions, the similarity score between two image backgrounds may be calculated more accurately, thereby comparing the similarity score between them more accurately.

It should be understood that the magnitude of the sequence number of each step in the above example does not imply the order of execution, and the order of execution of each process should be determined in terms of functionality and inherent logic thereof, and should not constitute any limitation on the implementation process of the example of the present disclosure.

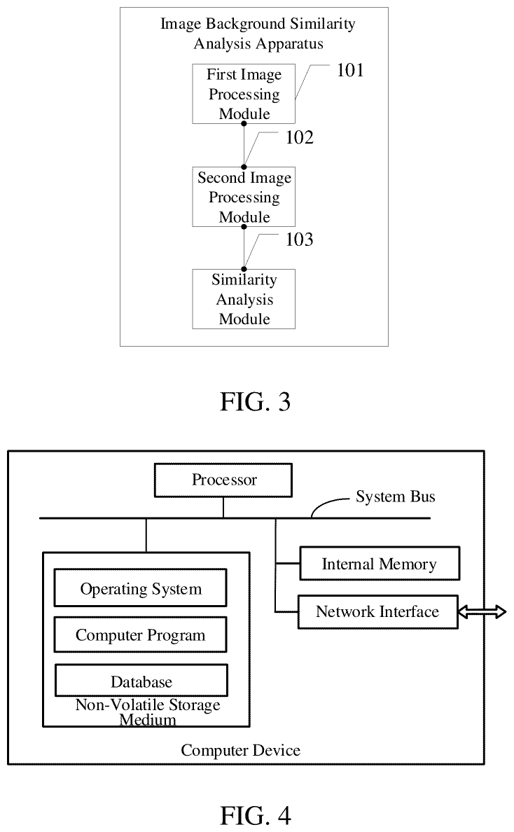

In one example, an image background similarity analysis apparatus is provided, which is in one-to-one correspondence with the image background similarity analysis method in the above examples. As shown in FIG. 3, the image background similarity analysis apparatus includes a first image processing module 101, a second image processing module 102, and a similarity analysis module 103. Each functional module is described in detail as follows:
the first image processing module 101 is configured for extracting an image background of a pre-acquired first image, and segmenting the extracted image background into an object region and a scene region; constructing a first distribution vector according to the object region of the first image, and allocating a first object region weight according to the first distribution vector; and calculating a weighting coefficient of the scene region in the first image, and utilizing the weighting coefficient of the first scene region to construct a first scene region weight;
the second image processing module 102 is configured for extracting an image background of a pre-acquired second image, and segmenting the extracted image background into an object region and a scene region; constructing a second distribution vector according to the object region of the second image, and allocating a second object region weight according to the second distribution vector; and calculating a weighting coefficient of the scene region in the second image, and utilizing the weighting coefficient of the second scene region to construct a second scene region weight; and
the similarity analysis module 103 is configured for calculating a similarity score of the image background of the first image and the image background of the second image according to the first object region weight, the first scene region weight, the second object region weight, and the second scene region weight.

In one example, the first image processing module 101:
when configured for extracting an image background of a pre-acquired first image, is configured for:
performing enhancement processing on the pre-acquired first image to obtain a first enhanced image;
extracting background pixels of the first enhanced image; and
performing background segmentation on the first enhanced image according to the background pixels to obtain the image background of the first image;
when configured for segmenting the extracted image background into an object region and a scene region, is configured for:
performing object mask segmentation on the image background of the first image to obtain the object region of the first image;
performing scene analysis on the image background of the first image to obtain an analysis result; and
performing scene mask segmentation on the image background of the first image according to the analysis result to obtain the scene region of the first image;
when configured for constructing a first distribution vector according to the object region of the first image, is configured for:
recognizing object categories of the object region of the first image;
performing homogeneous grouping according to the object categories to obtain the object categories corresponding to each group;
performing frequency statistics on the object categories corresponding to each group to obtain a frequency of each group of object categories; and
constructing a frequency distribution vector for the object region of the first image according to the frequency of each group of object categories to obtain the first distribution vector;
when configured for allocating a first object region weight according to the first distribution vector, is configured for:
performing feature extraction on the object region of the first image to obtain a first feature image;
constructing a dynamic weight vector corresponding to the object region of the first image according to the first distribution vector; and
weighting the first feature image and the dynamic weight vector to obtain the first object region weight; and
when configured for calculating a weighting coefficient of the scene region in the first image, is configured for:
dividing the scene region of the first image into a plurality of groups of partial scene regions;
performing feature analysis on the partial scene regions one by one to obtain partial scene features;
recognizing partial scene types according to the partial scene features;
performing weighting coefficient calculation on the partial scene regions one by one according to the partial scene types to obtain partial scene weighting coefficients corresponding to the partial scene regions; and
generating the weighting coefficient of the scene region in the first image according to a combination of the partial scene weighting coefficients.

In one example, the steps of the second image processing module 102 are the same as the steps of the first image processing module 101 described above, which will not be described in detail herein.

In one example, the similarity analysis module 103, when calculating a similarity score of the image background of the first image and the image background of the second image according to the first object region weight, the first scene region weight, the second object region weight, and the second scene region weight, is configured for:
calculating a similarity score of the object region of the first image and the object region of the second image according to the first object region weight and the second object region weight;
calculating a similarity score of the scene region of the first image and the scene region of the second image according to the first scene region weight and the second scene region weight;
calculating an initial similarity score of the image background of the first image and the image background of the second image; and
performing weighted fusion on the similarity score of the object regions, the similarity score of the scene regions, and the initial similarity score to obtain the similarity score of the image background of the first image and the image background of the second image.

The present disclosure provides an image background similarity analysis apparatus. For a similarity analysis service, an image background of a pre-acquired first image is extracted, and the extracted image background is segmented into an object region and a scene region; a first distribution vector is constructed according to the object region of the first image, and a first object region weight is allocated according to the first distribution vector; a weighting coefficient of the scene region in the first image is calculated, and the weighting coefficient of the first scene region is utilized to construct a first scene region weight; an image background of a pre-acquired second image is extracted, and the extracted image background is segmented into an object region and a scene region; a second distribution vector is constructed according to the object region of the second image, and a second object region weight is allocated according to the second distribution vector; a weighting coefficient of the scene region in the second image is calculated, and the weighting coefficient of the second scene region is utilized to construct a second scene region weight; and a similarity score of the image background of the first image and the image background of the second image is calculated according to the first object region weight, the first scene region weight, the second object region weight, and the second scene region weight. By calculating the weights of different regions, the similarity score between two image backgrounds may be calculated more accurately, thereby comparing the similarity score between them more accurately.

For specific limitation on the image background similarity analysis apparatus, reference may be made to the limitation on the image background similarity analysis method described above, which will not be described in detail herein. Each module in the image background similarity analysis apparatus described above may be completely or partially implemented by software, hardware, or a combination thereof. Each module described above may be embedded in a processor in an electronic device in the form of hardware or independent from the processor in the electronic device, and may also be stored in the processor in the electronic device in the form of software, so as to be convenient for the processor to call and execute operation corresponding to each module described above.

In one example, an electronic device is provided, and the electronic device may be a server, with an internal structure diagram as shown in FIG. 4. The electronic device includes a processor, a memory, a network interface, and a database which are connected by system buses, wherein the processor of the electronic device is used for providing calculation and control capabilities. The memory of the electronic device includes a non-volatile and/or volatile storage medium, and an internal memory. The non-volatile storage medium stores an operating system, a computer program, and a database. The internal memory provides an environment for running the operating system and the computer program in the non-volatile storage medium. The network interface of the electronic device is used for communicating with an external client through network connection. The computer program, when executed by the processor, implements the functions or steps at a server side of the image background similarity analysis method.

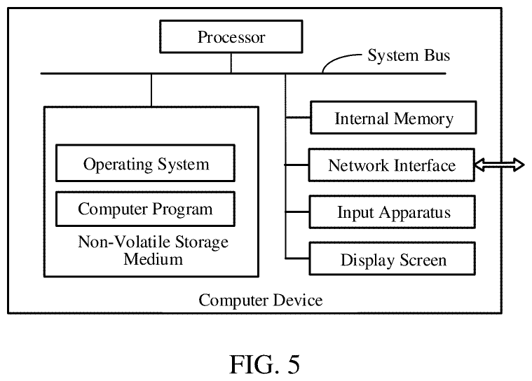

In one example, an electronic device is provided, and the electronic device may be a client, with an internal structure diagram as shown in FIG. 5. The electronic device includes a processor, a memory, a network interface, a display screen, and an input apparatus which are connected by system buses, wherein the processor of the electronic device is used for providing calculation and control capabilities. The memory of the electronic device includes a non-volatile storage medium, and an internal memory. The non-volatile storage medium stores an operating system and a computer program. The internal memory provides an environment for running the operating system and the computer program in the non-volatile storage medium. The network interface of the electronic device is used for communicating with an external server through network connection. The computer program, when executed by the processor, implements the functions or steps at a client side of the image background similarity analysis method.

In one example, an electronic device is provided, including a memory, a processor, and a computer program stored on the memory and runnable on the processor, wherein the computer program, when executed by the processor, implements the steps of:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

In one example, a computer-readable storage medium is provided, having a computer program stored thereon, wherein the computer program, when executed by a processor, implements the steps of:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

It should be noted that reference may be made to the relevant description of the server side and the client side in the foregoing method examples correspondingly for the above functions or steps which may be implemented by the computer-readable storage medium or the electronic device, which will not be described one by one to avoid repetition.

It will be understood by those ordinarily skilled in the art that implementing all or part of the flow in the methods of the examples described above may be completed by instructing the associated hardware by the computer program, the computer program may be stored in one non-volatile computer-readable storage medium, and the computer program, when executed, may include, for example, the flow of the example of each method described above, wherein any reference to the memory, storage, the database, or other media used in each example provided in the present application may include the non-volatile and/or volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. As illustration rather than limitation, the RAM is available in many forms such as a static RAM (SRAM), a dynamic RAM (DRAM), a synchronous DRAM (SDRAM), a double data rate SDRAM (DDRSDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM), and the like.

It will clearly understood by those skilled in the art that for the convenience and brevity of description, the division of various functional units and modules described above is merely exemplified, and in practical applications, the above functional allocation may be completed by different functional units and modules according to needs, namely, the internal structure of the apparatus is divided into different functional units or modules, so as to complete all or part of the functions described above.

The above examples are merely illustrative of the technical solutions of the present disclosure, rather than limiting them. In the examples of the present application, if software tools or components other than those of this company appear, they are merely used for illustrative introduction, and do not represent actual use; although the present disclosure has been described in detail with reference to the foregoing examples, it should be understood by those ordinarily skilled in the art that the technical solutions disclosed in various examples described above may still be modified, or some of the technical features thereof may be replaced by equivalents; and such modification or replacement does not enable the essence of the corresponding technical solutions to depart from the spirit and scope of the technical solutions of various examples of the present disclosure and is intended to be included within the scope of protection of the present disclosure.

What is claimed is:

1. An image background similarity analysis method, comprising the steps of:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

2. The image background similarity analysis method of claim 1, wherein the step of extracting an image background of a pre-acquired first image, comprises:
performing enhancement processing on the pre-acquired first image to obtain a first enhanced image;
extracting background pixels of the first enhanced image; and
performing background segmentation on the first enhanced image according to the background pixels to obtain the image background of the first image.

3. The image background similarity analysis method of claim 1, wherein the step of segmenting the extracted image background into an object region and a scene region, comprises:
performing object mask segmentation on the image background of the first image to obtain the object region of the first image;
performing scene analysis on the image background of the first image to obtain an analysis result; and
performing scene mask segmentation on the image background of the first image according to the analysis result to obtain the scene region of the first image.

4. The image background similarity analysis method of claim 1, wherein the step of constructing a first distribution vector according to the object region of the first image, comprises:
recognizing object categories of the object region of the first image;
performing homogeneous grouping according to the object categories to obtain the object categories corresponding to each group;
performing frequency statistics on the object categories corresponding to each group to obtain a frequency of each group of object categories; and
constructing a frequency distribution vector for the object region of the first image according to the frequency of each group of object categories to obtain the first distribution vector.

5. The image background similarity analysis method of claim 1, wherein the step of allocating a first object region weight according to the first distribution vector, comprises:
performing feature extraction on the object region of the first image to obtain a first feature image;
constructing a dynamic weight vector corresponding to the object region of the first image according to the first distribution vector; and
weighting the first feature image and the dynamic weight vector to obtain the first object region weight.

6. The image background similarity analysis method of claim 1, wherein the step of calculating a weighting coefficient of the scene region in the first image, comprises:
dividing the scene region of the first image into a plurality of groups of partial scene regions;
performing feature analysis on the partial scene regions one by one to obtain partial scene features;
recognizing partial scene types according to the partial scene features;
performing weighting coefficient calculation on the partial scene regions one by one the partial scene regions; and
generating the weighting coefficient of the scene region in the first image according to a combination of the partial scene weighting coefficients.

7. The image background similarity analysis method of claim 1, wherein the step of calculating a similarity score of the image background of the first image and the image background of the second image according to the first object region weight, the first scene region weight, the second object region weight, and the second scene region weight, comprises:
calculating a similarity score of the object region of the first image and the object region of the second image according to the first object region weight and the second object region weight;
calculating a similarity score of the scene region of the first image and the scene region of the second image according to the first scene region weight and the second scene region weight;
calculating an initial similarity score of the image background of the first image and the image background of the second image; and
performing weighted fusion on the similarity score of the object regions, the similarity score of the scene regions, and the initial similarity score to obtain the similarity score of the image background of the first image and the image background of the second image.

8. An electronic device, comprising: a memory and a processor, wherein the processor is electrically connected to the memory, the memory has a computer program executable by the at least one processor stored thereon, and the computer program, when executed by the at least one processor, causes the at least one processor to execute the steps of:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

9. The electronic device of claim 8, wherein the step of extracting an image background of a pre-acquired first image, comprises:
performing enhancement processing on the pre-acquired first image to obtain a first enhanced image;
extracting background pixels of the first enhanced image; and
performing background segmentation on the first enhanced image according to the background pixels to obtain the image background of the first image.

10. The electronic device of claim 8, wherein the step of segmenting the extracted image background into an object region and a scene region, comprises:
performing object mask segmentation on the image background of the first image to obtain the object region of the first image;
performing scene analysis on the image background of the first image to obtain an analysis result; and
performing scene mask segmentation on the image background of the first image according to the analysis result to obtain the scene region of the first image.

11. The electronic device of claim 8, wherein the step of constructing a first distribution vector according to the object region of the first image, comprises:
recognizing object categories of the object region of the first image;
performing homogeneous grouping according to the object categories to obtain the object categories corresponding to each group;
performing frequency statistics on the object categories corresponding to each group to obtain a frequency of each group of object categories; and
constructing a frequency distribution vector for the object region of the first image according to the frequency of each group of object categories to obtain the first distribution vector.

12. The electronic device of claim 8, wherein the step of allocating a first object region weight according to the first distribution vector, comprises:
performing feature extraction on the object region of the first image to obtain a first feature image;
constructing a dynamic weight vector corresponding to the object region of the first image according to the first distribution vector; and
weighting the first feature image and the dynamic weight vector to obtain the first object region weight.

13. The electronic device of claim 8, wherein the step of calculating a weighting coefficient of the scene region in the first image, comprises:
dividing the scene region of the first image into a plurality of groups of partial scene regions;
performing feature analysis on the partial scene regions one by one to obtain partial scene features;
recognizing partial scene types according to the partial scene features;
performing weighting coefficient calculation on the partial scene regions one by one according to the partial scene types to obtain partial scene weighting coefficients corresponding to the partial scene regions; and
generating the weighting coefficient of the scene region in the first image according to a combination of the partial scene weighting coefficients.

14. The electronic device of claim 8, wherein the step of calculating a similarity score of the image background of the first image and the image background of the second image according to the first object region weight, the first scene region weight, the second object region weight, and the second scene region weight, comprises:
calculating a similarity score of the object region of the first image and the object region of the second image according to the first object region weight and the second object region weight;
calculating a similarity score of the scene region of the first image and the scene region of the second image according to the first scene region weight and the second scene region weight;
calculating an initial similarity score of the image background of the first image and the image background of the second image; and
performing weighted fusion on the similarity score of the object regions, the similarity score of the scene regions, and the initial similarity score to obtain the similarity score of the image background of the first image and the image background of the second image.

15. A non-volatile computer-readable storage medium having a computer program stored thereon, wherein the computer program, when executed by one or more processors, causes the one or more processors to execute the steps of:
extracting an image background of a pre-acquired first image, and segmenting the extracted image background into an object region and a scene region;
constructing a first distribution vector according to the object region of the first image, and allocating a first object region weight according to the first distribution vector;
calculating a weighting coefficient of the scene region in the first image, and utilizing the weighting coefficient of the first scene region to construct a first scene region weight;
extracting an image background of a pre-acquired second image, and segmenting the extracted image background into an object region and a scene region;
constructing a second distribution vector according to the object region of the second image, and allocating a second object region weight according to the second distribution vector;
calculating a weighting coefficient of the scene region in the second image, and utilizing the weighting coefficient of the second scene region to construct a second scene region weight; and
calculating a similarity score of the image background of the first image and the image background of the second image according to the first object region weight, the first scene region weight, the second object region weight, and the second scene region weight.

16. The non-volatile computer-readable storage medium of claim 15, wherein the step of segmenting the extracted image background into an object region and a scene region, comprises:
performing object mask segmentation on the image background of the first image to obtain the object region of the first image;
performing scene analysis on the image background of the first image to obtain an analysis result; and
performing scene mask segmentation on the image background of the first image according to the analysis result to obtain the scene region of the first image.

17. The non-volatile computer-readable storage medium of claim 15, wherein the step of constructing a first distribution vector according to the object region of the first image, comprises:
recognizing object categories of the object region of the first image;
performing homogeneous grouping according to the object categories to obtain the object categories corresponding to each group;
performing frequency statistics on the object categories corresponding to each group to obtain a frequency of each group of object categories; and
constructing a frequency distribution vector for the object region of the first image according to the frequency of each group of object categories to obtain the first distribution vector.

18. The non-volatile computer-readable storage medium of claim 15, wherein the step of allocating a first object region weight according to the first distribution vector, comprises:
performing feature extraction on the object region of the first image to obtain a first feature image;
constructing a dynamic weight vector corresponding to the object region of the first image according to the first distribution vector; and
weighting the first feature image and the dynamic weight vector to obtain the first object region weight.

19. The non-volatile computer-readable storage medium of claim 15, wherein the step of calculating a weighting coefficient of the scene region in the first image, comprises:
dividing the scene region of the first image into a plurality of groups of partial scene regions;
performing feature analysis on the partial scene regions one by one to obtain partial scene features;
recognizing partial scene types according to the partial scene features;
performing weighting coefficient calculation on the partial scene regions one by one the partial scene regions; and
generating the weighting coefficient of the scene region in the first image according to a combination of the partial scene weighting coefficients.

20. The non-volatile computer-readable storage medium of claim 15, wherein the step of calculating a similarity score of the image background of the first image and the image background of the second image according to the first object region weight, the first scene region weight, the second object region weight, and the second scene region weight, comprises:
calculating a similarity score of the object region of the first image and the object region of the second image according to the first object region weight and the second object region weight;
calculating a similarity score of the scene region of the first image and the scene region of the second image according to the first scene region weight and the second scene region weight;
calculating an initial similarity score of the image background of the first image and the image background of the second image; and
performing weighted fusion on the similarity score of the object regions, the similarity score of the scene regions, and the initial similarity score to obtain the similarity score of the image background of the first image and the image background of the second image.
